(19) United States
(12) Patent Application Publication
(10) Pub. No.: US 2021/0208535 A1
(43) Pub. Date: Jul. 8, 2021

(54) SYSTEM AND METHOD FOR DIGITAL HOLOGRAPHIC IMAGING

(71) Applicant: ELECTRONICS AND TELECOMMUNICATIONS RESEARCH INSTITUTE, Daejeon (KR)

(72) Inventors: Gi Hyeon MIN, Gwangju (KR); Keo Sik KIM, Gwangju (KR); Hyun Seo KANG, Gwangju (KR); Kye Eun KIM, Naju (KR); Sung Chang KIM, Gwangju (KR); Ji Hyoung RYU, Jeonju (KR); Si Woong PARK, Gwangju (KR); Hyoung Jun PARK, Gwangju (KR); Dong Hoon SON, Gwangju (KR); Chan Il YEO, Gwangju (KR); Dong Soo LEE, Gwangju (KR); Byung Tak LEE, Suwon (KR); Young Soon HEO, Gwangju (KR)

(21) Appl. No.: 16/825,571

(22) Filed: Mar. 20, 2020

(30) Foreign Application Priority Data
Jan. 7, 2020 (KR) 10-2020-0002243

(51) Int. Cl. G03H 1/04; G03H 1/08; G03H 1/22; G03H 1/16

(52) U.S. Cl. CPC G03H 1/0443; G03H 1/0866; G03H 2001/005; G03H 1/16; G03H 1/2286; G03H 1/2205

(57) ABSTRACT

Provided are a system and method for digital holographic imaging which are not affected by external vibrations. The system for digital holographic imaging includes a light source and optical system section configured to split generated beams and including a sample through which the beams pass, a lens, and a grating disposed behind the lens; an object signal acquisition section configured to receive the split beams and acquire an interference signal; and an image processor configured to acquire a three-dimensional (3D) image of an object by using the acquired interference signal.

### CROSS-REFERENCE TO RELATED APPLICATION

This application claims priority to and the benefit of Korean Patent Application No. 10-2020-0002243, filed on Jan. 7, 2020, the disclosure of which is incorporated herein by reference in its entirety.

### BACKGROUND

### 1. Field of the Invention

The present invention relates to a system and method for digital holographic imaging which are not affected by external vibrations.

### 2. Discussion of Related Art

A digital holographic system acquires the shape and surface information of a three-dimensional (3D) object and measures the internal structure and refractive index.

A digital holographic system according to a related art is sensitive to vibrations and thus requires equipment for removing vibrations such as a vibration isolation table. For this reason, the digital holographic system is highly priced equipment and suffers from low market competitiveness.

To solve this problem, a system which is less sensitive to vibrations was proposed. However, such a system requires many optical devices which lead to an increase in size and lower the price competitiveness.

### SUMMARY OF THE INVENTION

The present invention is directed to providing a system for three-dimensional (3D) digital holographic imaging which does not require equipment for removing slight vibrations present in surroundings (a vibration isolation table, an optical table, or the like), leads to a reduction in system size by making it possible to simplify the configuration of an optical system, and is easy to move without limitations on the place of usage, and a method for the same.

According to an aspect of the present invention, there is provided a system for digital holographic imaging, the system including: a light source and optical system section configured to split generated beams and including a sample through which the beams pass, a lens, and a grating disposed behind the lens; an object signal acquisition section configured to receive the split beams and acquire an interference signal; and an image processor configured to acquire a three-dimensional (3D) image of an object by using the acquired interference signal.

According to another aspect of the present invention, there is provided a method for digital holographic imaging, the method including: splitting beams, which have passed through a sample and a lens, through a grating; receiving the split beams and acquiring an interference signal; and acquiring a 3D image of an object by using the acquired interference signal.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a system for digital holographic imaging according to an exemplary embodiment of the present invention;

FIG. 2 is a detailed diagram of the system for digital holographic imaging according to an exemplary embodiment of the present invention;

FIG. 3A and FIG. 3B show cross-sectional view of a charge-coupled device (CCD) of the system for digital holographic imaging according to an exemplary embodiment of the present invention;

FIG. 4 is a flowchart illustrating a process of acquiring a three-dimensional (3D) image of an object from an interference signal according to an exemplary embodiment of the present invention; and

FIG. 5A and FIG. 5B show a 3D image of a polystyrene particle acquired by using the system for digital holographic imaging according to an exemplary embodiment of the present invention.

### DETAILED DESCRIPTION OF EXEMPLARY EMBODIMENTS

The aforementioned objects, other objects, advantages, and features of the present invention and methods for achieving them will be made clear from embodiments described in detail below with reference to the accompanying drawings.

However, the present invention may be embodied in many different forms and should not be construed as being limited to the embodiments set forth herein. Rather, these embodiments are provided so that this disclosure will be thorough and complete and will fully convey the scope of the present invention to those of ordinary skill in the art to which the present invention pertains. The present invention is defined by the claims.

Meanwhile, terms used herein are for the purpose of describing embodiments and are not intended to limit the present invention. As used herein, the singular forms are intended to include the plural forms as well unless the context clearly indicates otherwise. The terms “comprises” and/or “comprising” used herein indicate the presence of stated elements, steps, operations, and/or devices and do not preclude the presence or addition of one or more other elements, steps, operations, and/or devices.

Hereinafter, the reason that the present invention is proposed will be described first to help those of ordinary skill in the art with understanding, and then exemplary embodiments of the present invention will be described.

A digital holographic system is an apparatus for acquiring the shape and surface information of a three-dimensional (3D) object and measuring the internal structure and refractive index and makes high-precision analysis possible in a biomedical or industrial field.

Also, a digital holographic system can acquire the 3D information of an object required by a 3D printer within a short time.

Digital holographic technologies according to related arts include phase shifting, off-axis digital holography, Fresnel incoherent holography (FINCH), and conoscopic holography.

However, these technologies are sensitive to vibrations and thus require a vibration isolation table. Consequently, it is necessary to configure a large imaging system.

In other words, it is not possible to use the technologies in general industrial environments, and the technologies involve expensive equipment, and thus the market competitiveness is low.

To solve these problems, an imaging system is proposed which is not affected by vibrations and which is reduced in size by simplification.

Korea Advanced Institute of Science and Technology (KAIST) has proposed a method of acquiring a holographic image by using a half wave plate, Wollaston plate, and a linear polarizer in K. Lee, and Y. Park, “Quantitative phase imaging unit,” Opt. Lett, 39(12), 3630-3633 (2014).

A. Massachusetts institute of technology (MIT) group has proposed a holographic imaging system employing a grating and a spatial filter in G. Popescu, T. Ikeda, R. R. Dasari, and M. S. Feld, “Diffraction phase microscopy for quantifying cell structure and dynamics,” Opt. Lett. 31(6), 775-777 (2006).

The aforementioned two systems may be less sensitive to vibrations but require many optical devices. Consequently, the systems have a large size and low price competitiveness.

The present invention is intended to solve the aforementioned problems. The present invention proposes a system in which a grating is added to the front of a charge-coupled device (CCD) of a two-dimensional (2D) microscope, that is, a system for 3D digital holographic imaging which does not require separate equipment for removing slight vibrations present in surroundings (a vibration isolation table, an optical table, or the like), leads to a reduction in system size by making it possible to simplify the configuration of an optical system, and is easy to move without limitations on the place of usage, and a method for 3D digital holographic imaging.

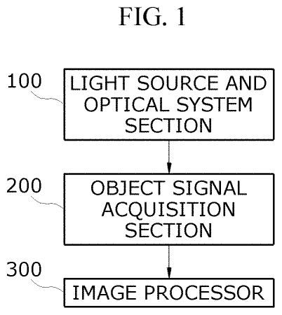

Hereinafter, exemplary embodiments of the present invention will be described with reference to FIGS. 1 to 5.

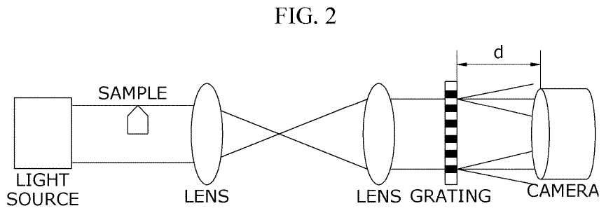

FIG. 1 is a block diagram of a system for digital holographic imaging according to an exemplary embodiment of the present invention, and FIG. 2 is a detailed diagram of the system for digital holographic imaging according to an exemplary embodiment of the present invention.

A system for digital holographic imaging according to an exemplary embodiment of the present invention includes a light source and optical system section 100 which includes a sample 120 through which generated beams pass, a lens 130, and a grating 140 disposed behind the lens 130 and which is configured to split the beams, an object signal acquisition section 200 which receives the split beams and acquires an interference signal, and an image processor 300 which acquires a 3D image of an object by using the acquired interference signal.

The object signal acquisition section 200 is an element which acquires a signal of an object through a CCD, a complementary metal-oxide semiconductor (CMOS) camera, or the like.

Coherent beams generated by a light source 110 pass through the sample 120, the lens 130, and then the grating 140 disposed in front of the object signal acquisition section 200 and are split into 0th-order, +1st-order, and −1st-order beams.

Referring to FIG. 2, the 0th-order, +1st-order, and −1st-order beams are shown in blue, yellow, and red, respectively.

As an optical system according to an exemplary embodiment of the present invention, an objective microscope for enlarging an object may be attached, or an optical system for reducing an object may be configured.

The grating 140 according to an exemplary embodiment of the present invention may be a sinusoidal amplitude grating or a Ronchi grating.

Since the sample 120 according to an exemplary embodiment of the present invention is placed in half of a beam area, sample beams correspond to the half of the beam area, and the other half corresponds to reference beams in which the sample 120 is not present.

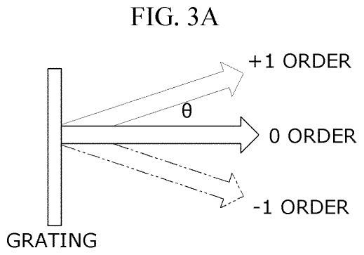

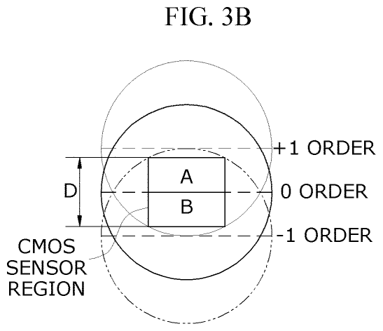

When such beams arrive at the object signal acquisition section 200, the beams are split into regions A and B at a surface of a CCD chip as shown in FIG. 3B.

The +1st-order reference beam, the 0th-order sample beam, and the −1st-order sample beam overlap in region A, and the −1st-order sample beam, the 0th-order reference beam, and the +1st-order reference beam overlap in region B.

In region B of the CCD chip shown in FIG. 3A and FIG. 3B, a wave E_{B} is represented by [Equation 1] below.

FIG. 3A shows the propagation of beams passing through a grating, and FIG. 3B shows a diagram of beams overlapping in a CMOS plane.

D is a CMOS chip size, and θ is the angle between 3 order beams. A is a region in which the −1st-order and 0th-order sample beams and the +1st-order reference beam are recorded, and B is a region in which the −1st-order sample beam and the 0th-order and +1st-order reference beams are recorded.

E_{A}≈e^{iθ}^{ᵣ}^{⁰}e^{iθ}^{ₛ}^{^{−1}}+e^{iθ}^{ᵣ}^{⁺¹} [Equation 1]

Here, e^{iθ}^{ᵣ}^{⁰} and e^{iθ}^{ᵣ}^{⁺¹} are 0th-order and +1st-order reference beams, and e^{iθ}^{ₛ}^{^{−1}} is a −1st-order sample beam.

From these beams, the CCD acquires an interference signal represented by [Equation 2] below.

I_{A}≈cos(θᵣ⁰−θᵣ⁺¹)+cos(θᵣ⁰−θₛ⁻¹)+cos(θᵣ⁺¹−θₛ⁻¹)+I₀ [Equation 2]

In [Equation 2], I₀ is a direct current (DC) term.

In [Equation 2], the fourth term I₀ is a DC term. In the first term, the 0th-order and +1st-order beams interfere with each other, and in the second term, the 0th-order and −1st-order beams interfere with each other.

In the two terms, beams have a difference of 1 in order and thus have a spatial-carrier frequency of 1/Λ.

However, in the third term, beams have a difference of 2 in order and thus have a spatial-carrier frequency of 2/Λ.

Therefore, when fast Fourier transform (FFT) is applied, only sample information is present at a 2nd-order frequency.

Consequently, the image processor 300 according to an exemplary embodiment of the present invention acquires 3D information of an object by extracting only a −2nd-order or +2nd-order frequency (an object information frequency signal).

A process of acquiring a 3D image of an object from the interference signal of region B shown in FIG. 3B is performed by the image processor 300. The image processor 300 extracts an object information frequency signal by applying FFT to the interference signal acquired through the object signal acquisition section 200 and acquires 3D information of the object through an inverse FFT.

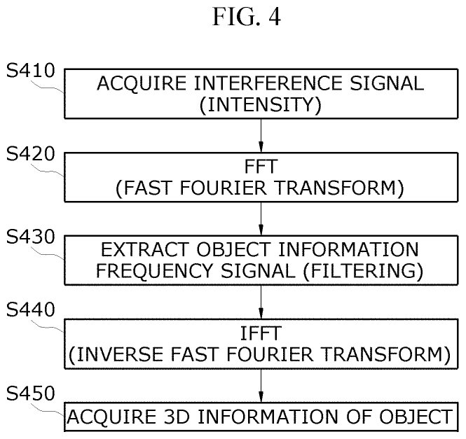

In other words, as shown in FIG. 4, a process of acquiring a 3D image of an object from an interference signal includes an operation S410 of acquiring an interference signal (intensity), an operation S420 of applying FFT to the interference signal, an operation S430 of extracting an object information frequency signal, an operation S440 of applying inverse FFT to the object information frequency signal, and an operation S450 of acquiring 3D information of the object.

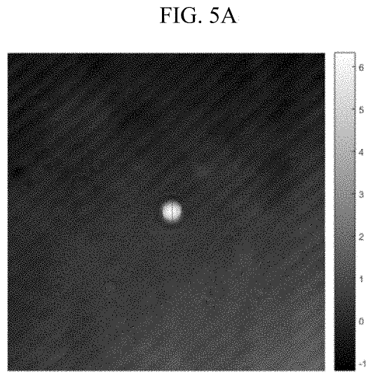

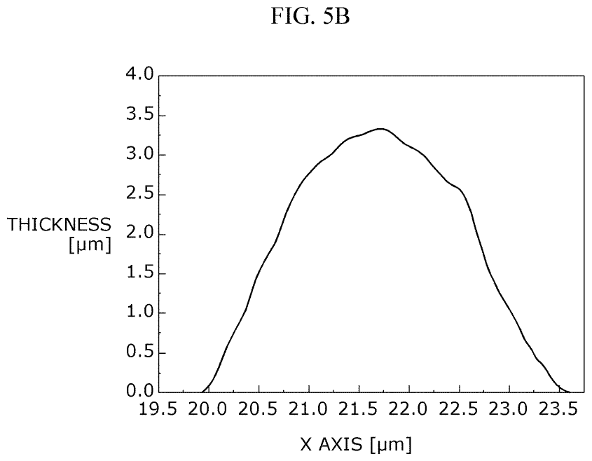

FIG. 5A and FIG. 5B shows a 3D image of a polystyrene particle acquired by using the system for digital holographic imaging according to an exemplary embodiment of the present invention.

The image of a particle having a size of 3.55 p.m and a refractive index of 1.76 is shown on the FIG. 5A, and a graph on the FIG. 5B shows the 3D image of a cross-section taken along a red line in the left image.

Referring to the graph on FIG. 5B, the highest thickness is 3.33 μm, which shows an error of about 6%.

A method for digital holographic imaging according to an exemplary embodiment of the present invention includes an operation of splitting beams, which have passed through a sample and a lens, through a grating, an operation of receiving the split beams and acquiring an interference signal, and an operation of acquiring a 3D image of an object by using the acquired interference signal.

The operation of splitting the beams through the grating employs a coherent light source and an optical system for optical alignment. In the operation, coherent beams generated by the light source pass through the sample and the lens and then split into 0th-order, +1st-order, and −1st-order beams through the grating.

The grating may be a sinusoidal amplitude grating or a Ronchi grating.

In the operation of acquiring the interference signal, sample beams and reference beams are received by the sample placed in half of a beam area so that an interference signal is acquired. As shown in FIG. 3A and FIG. 3B, a −1st-order sample beam, a 0th-order sample beam, and a +1st-order reference beam overlap in region A, and the −1st-order sample beam, a 0th-order reference beam, and the +1st-order reference beam overlap in region B.

The interference signal acquired by a CCD is represented by [Equation 2] above.

In the operation of acquiring the 3D image of the object according to an exemplary embodiment of the present invention, an object information frequency signal is extracted by applying FFT to the acquired interference signal, and 3D information of the object is acquired by applying inverse FFT to the object information frequency signal.

In order for images of ±1st-order samples to not overlap, the distance between centers of ±1st-order beams is longer than the size of the CCD chip. in other words, as represented by [Equation 3] below, a distance r between the centers of the 0th-order and +1st-order beams is greater than the half of a CCD size.

$$r \geq \frac{D}{2} \qquad [ Equation 3 ]$$

Here, D is the size of the CCD chip.

d is the distance from a CCD position to a grating position. When θ is small, tanθ≈sinθ and sinθ is inversely proportionate to a grating period Λ and proportionate to λ as shown in [Equation 4].

sin θ=λ/Λ [Equation 4]

Therefore, r≈d tan θ=dλ/Λ. When the relational expression is substituted into [Equation 3], an optimal relationship among the distance from the CCD position to the grating position, the CCD size D, and the grating period Λ is acquired as shown in [Equation 5] below.

$$d \frac{λ}{Λ} \geq \frac{D}{2} \qquad [ Equation 5 ]$$

According to the Nyquist Theorem, the maximum spatial frequency of interference is 1/2p so that a CCD camera may distinguish an interference pattern.

Here, p is the pixel size of the CCD.

Since the maximum spatial frequency is 2/Λ, the grating period and the pixel size satisfy the relationship of [Equation 6] below.

Λ≥4p [Equation 6]

According to an exemplary embodiment of the present invention, a 601 p/mm grating is used, and the pixel size of the CCD is 2.75 m. These satisfy the Nyquist sampling condition.

A system and method for digital holographic imaging according to exemplary embodiments of the present invention are implemented by adding one grating sheet to the front of a CCD in an existing 2D microscope, and thus the reference arm of an existing 3D microscope is omitted. Consequently, the system is reduced in size and becomes economical.

The system and method according to exemplary embodiments of the present invention are insensitive to vibrations fundamentally occurring in their surroundings and do not require equipment for removing vibrations such as an optical table or a vibration isolation table. Also, since the structure of an optical system is simplified, it is convenient to move without limitations on the place of use.

According to exemplary embodiments of the present invention, it is possible to image the 3D surfaces and internal structures of objects, such as a cell and a semiconductor plate, and the present invention can be applied to development of equipment for precisely analyzing the refractive index, surface roughness, etc. of an object.

Effects of the present invention are not limited to those mentioned above, and other effects which have not been mentioned should be clearly understood by those of ordinary skill in the art from the above descriptions.

The present invention has been described in detail above with reference to exemplary embodiments. Those of ordinary skill in the technical field to which the present invention pertains should be able to understand that various modifications and alterations can be made without departing from the essential features of the present invention. Therefore, it should be understood that the disclosed embodiments are not limiting but illustrative. The scope of the present invention is defined not by the above description but by the following claims, and it should be understood that all changes or modifications derived from the scope and equivalents of the claims fall within the scope of the present invention.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk. (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. in addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A system for digital holographic imaging, the system comprising:
a light source and optical system section configured to split generated beams and including a sample through which the beams pass, a lens, and a grating disposed behind the lens:
an object signal acquisition section configured to receive the split beams and acquire an interference signal; and
an image processor configured to acquire a three-dimensional image of an object by using the interference signal acquired by the object signal acquisition section.

2. The system of claim 1, wherein the sample is disposed within half of an area of the generated beams.

3. The system of claim 1, wherein the grating splits the beams into 0th-order, +1st-order, and −1st-order beams.

4. The system of claim 1, wherein the grating is a sinusoidal amplitude grating or a Ronchi grating.

5. The system of claim 1, wherein the object signal acquisition section acquires the interference signal by using sample beams and reference beams.

6. The system of claim 1, wherein the image processor extracts an object information frequency signal by applying fast Fourier transform to the acquired interference signal and acquires three-dimensional information of the object by applying inverse fast Fourier transform to the object information frequency signal.

7. A method for digital holographic imaging, the method comprising:
(a) splitting beams, which have passed through a sample and a lens, through a grating;
(b) receiving the split beams and acquiring an interference signal; and
(c) acquiring a three-dimensional image of an object by using the acquired interference signal.

8. The method of claim 7, wherein operation (a) comprises splitting the beams into 0th-order, +1st-order, and -1st-order beams through a sinusoidal amplitude grating or a Ronchi grating.

9. The method of claim 7, wherein operation (b) comprises receiving the sample beams and reference beams and acquiring the interference signal through the sample placed within half of a beam area.

10. The method of claim 7, wherein operation (c) comprises extracting an object information frequency signal by applying fast Fourier transform to the acquired interference signal and acquiring three-dimensional information of the object by applying inverse fast Fourier transform to the object information frequency signal.
